(19) United States
(12) Patent Application Publication
(10) Pub. No.: US 2009/0014261 A1
(43) Pub. Date: Jan. 15, 2009

(54) Apparatus for controlling aircraft parking brakes

(76) Inventors: Jonathan Sidney Edelson, Portland, OR (US); Isaiah Watas Cox, Baltimore, MD (US); Todd Tripp, Fort St. John (CA)

Correspondence Address: Borealis Technical Limited, 23545 NW Skyline Blvd, North Plains, OR, 97133-9204, US

(21) Appl. No.: 12/217,358

(22) Filed: Jul. 3, 2008

Related U.S. Application Data
(63) Continuation-in-part of application No. PCT/US2007/019054, filed on Aug. 29, 2007.
(60) Provisional application No. 60/958,602, filed on Jul. 5, 2007.
(60) Provisional application No. 60/958,601, filed on Jul. 5, 2007.

(30) Foreign Application Priority Data
Aug. 29, 2006 (GB) 0616984.1

(51) Int. Cl. F16D 65/36

(52) U.S. Cl. 188/156

(57) ABSTRACT

An apparatus for remotely controlling an aircraft having a self-propelled nosewheel, on the ground, comprises parking brakes; an APU on said aircraft; control means for applying and releasing said parking brakes; control means for turning on and off said APU; transmitting means for transmitting information to said parking brakes and said APU; receiving means for receiving information at said parking brakes; and receiving means for receiving information at said APU.

### CROSS-REFERENCE TO RELATED APPLICATIONS

This application is a Continuation-in-Part of International Application PCT/US2007/019054, filed Aug. 29, 2007, and which designates the United States, which international application was published on Apr. 24, 2008, as International Publication WO08048393 in the English language. International Application No. PCT/US2007/019054 claims the benefit of GB Patent Application No. 0616984.1 filed on Aug. 29, 2006, and of U.S. Provisional Patent Application No. 60/958,602 filed on Jul. 5, 2007. This application claims the benefit of U.S. Provisional Patent Application No. 60/958,601, filed Jul. 5, 2007.

### BACKGROUND OF THE INVENTION

The invention relates to aircraft ground movement and in particular to controlling the movement of an aircraft propelled by a self-propelled nosewheel, on the ground.

Aircraft brakes to be used on the ground are known in the art.

GB1435870 to Aerospatiale discloses a method of controlling the disc pressure of a carbon disc brake for an aircraft. FIG. 1 of the patent shows the brake operated by a pedal 7, which pedal is pictured physically connected to and in proximity to an aircraft wheel, thus is can be seen that this patent assumes the pilot to be operating the brake from within the aircraft.

EP0186219 to Zoerb discloses a brake control system wherein hydraulic wheel brakes in an aircraft are controlled by a pilot from a cockpit via a pedal. Here it can also be observed that the normal point of operation of aircraft brakes is from a cockpit, by the pilot, via a pedal.

Motors providing high torque at low speeds are known in the art. Specifically, such motors are known that are designed for the purpose of propelling aircraft on the ground.

WO05112584 to Edelson discloses a motor-generator machine comprising a slotless AC induction motor. The motor disclosed therein is an AC induction machine comprising an external electrical member attached to a supporting frame and an internal electrical member attached to a supporting core; one or both supports are slotless, and the electrical member attached thereto comprises a number of surface mounted conductor bars separated from one another by suitable insulation. An airgap features between the magnetic portions of core and frame. Electrical members perform the usual functions of rotor and stator but are not limited in position by the present invention to either role. The stator comprises at least three different electrical phases supplied with electrical power by an inverter. The rotor has a standard winding configuration, and the rotor support permits axial rotation.

WO2006002207 to Edelson discloses a motor-generator machine comprising a high phase order AC machine with short pitch winding. Disclosed therein is a high phase order alternating current rotating machine having an inverter drive that provides more than three phases of drive waveform of harmonic order H, and characterized in that the windings of the machine have a pitch of less than 180 rotational degrees. Preferably the windings are connected together in a mesh, star or delta connection. The disclosure is further directed to selection of a winding pitch that yields a different chording factor for different harmonics. The aim is to select a chording factor that is optimal for the desired harmonics.

Disclosed in WO2006/065988 to Edelson is a motor-generator machine comprising stator coils wound around the inside and outside of a stator, that is, toroidally wound. The machine may be used with a dual rotor combination, so that both the inside and outside of the stator may be active. Even order drive harmonics may be used, if the pitch factor for the windings permits them. In a preferred embodiment, each of the coils is driven by a unique, dedicated drive phase. However, if a number of coils have the same phase angle as one another, and are positioned on the stator in different poles, these may alternatively be connected together to be driven by the same drive phase. In a preferred embodiment, the coils are connected to be able to operate with 2 poles, or four poles, under H=1 where H is the harmonic order of the drive waveform. The coils may be connected together in series, parallel, or anti-parallel.

In U.S. patent application Ser. No. 11/403,402, filed Apr. 12, 2006, a motor-generator machine is disclosed comprising a polyphase electric motor which is preferably connected to drive systems via mesh connections to provide variable V/Hz ratios. The motor-generator machine disclosed therein comprises an axle; a hub rotatably mounted on said axle; an electrical induction motor comprising a rotor and a stator; and an inverter electrically connected to said stator; wherein one of said rotor or stator is attached to said hub and the other of said rotor or stator is attached to said axle. Such a machine may be located inside a vehicle drive wheel, and allows a drive motor to provide the necessary torque with reasonable system mass.

International Appl. No. PCT/US2006/12483, filed Apr. 5, 2006, discloses a motor-generator machine comprising an induction and switched reluctance motor designed to operate as a reluctance machine at low speeds and an inductance machine at high speeds. The motor drive provides more than three different phases and is capable of synthesizing different harmonics. As an example, the motor may be wound with seven different phases, and the drive may be capable of supplying fundamental, third and fifth harmonic. The stator windings are preferably connected with a mesh connection. The system is particularly suitable for a high phase order induction machine drive systems of the type disclosed in U.S. Pat. Nos. 6,657,334 and 6,831,430. The rotor, in combination with the stator, is designed with a particular structure that reacts to a magnetic field configuration generated by one drive waveform harmonic. The reaction to this harmonic by the rotor structure produces a reluctance torque that rotates the rotor. For a different harmonic drive waveform, a different magnetic field configuration is produced, for which the rotor structure defines that substantially negligible reluctance torque is produced. However, this magnetic field configuration induces substantial rotor currents in the rotor windings, and the currents produce induction based torque to rotate the rotor.

### BRIEF SUMMARY OF THE INVENTION

It would be advantageous to have a means for controlling parking brakes of an aircraft on the ground. It would be further advantageous for this means to be remote from said aircraft and to be operable by airport ground staff.

It is an object of the present invention to provide means for controlling the parking brakes of an aircraft, propelled by a self-propelled nosewheel, on the ground.

It is a further object of the invention to provide said means remotely from said aircraft, which means can be operated by airport ground staff.

It is a further object of the invention to provide said means which are intuitive, safe, and easy to operate.

It is a further object of the invention to provide said means alongside means for controlling other related properties of said aircraft, for example, speed, direction, power.

An apparatus for remotely controlling an aircraft having a self-propelled nosewheel, on the ground, is disclosed, comprising: parking brakes; an APU on said aircraft; control means for applying and releasing said parking brakes; control means for turning on and off said APU; transmitting means for transmitting information to said parking brakes and said APU; receiving means for receiving information at said parking brakes; and receiving means for receiving information at said APU.

### BRIEF DESCRIPTION OF THE SEVERAL VIEWS OF THE DRAWINGS

The invention will now be described in detail with reference to the following figure, in which:

FIG. 1 shows the control unit of the first embodiment of the invention alongside an aircraft.

### DETAILED DESCRIPTION OF THE INVENTION

An apparatus for remotely controlling an aircraft having a self- propelled nosewheel, on the ground, comprising: parking brakes; an APU on said aircraft; control means for applying and releasing said parking brakes; control means for turning on and off said APU; transmitting means for transmitting information to said parking brakes and said APU; receiving means for receiving information at said parking brakes; and receiving means for receiving information at said APU.

In the following, the control means for applying and releasing said parking brakes (brake means); control means for turning on and off said APU (APU means); and transmitting means for transmitting information to said parking brakes and said APU are collectively termed the ‘control unit’.

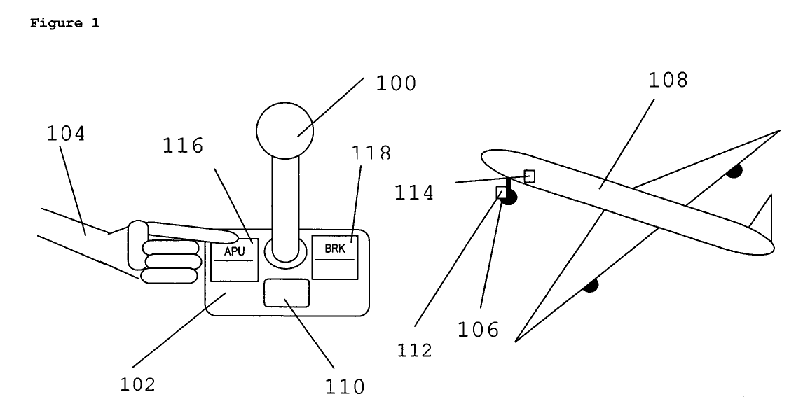

FIG. 1 shows a first embodiment of the invention which further comprises an arm for controlling the direction of said aircraft (although this is not a necessary or defining feature of the invention). APU means 116 comprises a switch which ground staff member 104 can switch to the on or off position to turn the APU power supply on or off respectively. Brake means 118 comprises a switch which ground staff member 104 can switch to the on or off position for applying and releasing the brakes respectively. Arm 100 is moveably attached at its base to control unit 102, for controlling the movements of said aircraft. Signals from APU switch 116 are transmitted via transmitting means 110 to APU receiving means 114 on board aircraft 108 for controlling the APU. Signals from brake switch 118 are transmitted via transmitting means 110 to brake receiving means 112 on board aircraft 108, for controlling the brakes. (Signals from arm 100 are also transmitted and received.)

Said brake control means, APU control means and transmitting means, collectively called the control unit, are preferably made from weather resistant materials appropriate for use outdoors in many weather conditions.

Said self-propelled nosewheel is preferably propelled by a mesh connected, high phase order electric induction motor, and more preferably by one of the motors described in the background section of this patent. However said nosewheel may be propelled by any drive means.

Said control unit is preferably attached to the ground or mounted on equipment attached to the ground, near a gate at an airport. An advantage of this is that it will always be at a known location. Said control unit may also be attached to any airport gate equipment such as a passenger loading bridge or other portable gate equipment. An advantage of this is that said control unit can be moved to a gate at which it is required. Said control unit may also be attached to a maintenance hanger, a runway, a taxiway, an apron or other location where aircraft need to be moved, or attached to any equipment in such areas.

Said control unit may further comprise a security cover for preventing unauthorized use, which covers one or both of said control means or restricts their movement, whereby said control means cannot be accessed or operated without a physical key, electronic key, number code, letter code, fingerprint recognition, iris recognition, barcode recognition, or any other known means for unlocking a cover.

Said control unit may comprise a transmittal-restricting safety feature whereby operations of one or both of said control means are not transmitted to said nosewheel unless said transmittal-restricting safety feature has been disabled. Said feature may be disabled using a physical key, electronic key, number code, letter code, fingerprint recognition, iris recognition, barcode recognition or any other known means of safety feature disabling.

Said control unit may further comprise an emergency stop feature wherein emergency stopping means are located on the control means. Said emergency stopping means is preferably a large, red, mushroom-shaped button as is commonly used for this purpose but may also be any other form of button, switch, lever, or any other known means for sending an immediate signal. Upon operating the emergency stopping means, a signal is sent via said transmitting means to said receiving means to stop the drive means and/or apply brakes. Said emergency stopping means overrides all other signals. Protection may be provided to prevent accidental operation of the emergency stopping feature.

Said control unit may further comprise a fire suppression feature wherein operating fire suppression control means sends a signal via said transmission means and said receiving means to the fire suppression system of said APU. The fire suppression system is usually a dry chemical fire extinguisher mounted in the vicinity of said APU which, when activated, discharges the chemical to smother the fire. The fire suppression feature is not limited to activating such a system and may be applied to activate any fire suppression system for any APU. Said fire suppression control means may be a button, switch, lever or any other known means of sending an immediate signal. Protection may be provided to prevent accidental operation of the fire suppression feature.

Said brake control means and said APU control means are preferably switches but may also be levers, push buttons, sliders, touch pads, optical sensors, heat sensors, pedals or any other type of control means capable of transmitting an on and an off signal. Said brake control means and said APU control means are preferably situated as shown in FIG. 1 but may also be in each in a unique control unit, together in a control unit separate from said arm, attached to said aircraft fuselage or undercarriage, attached to airport equipment, attached to ground staff personal equipment, or at any other location.

Said transmitting means for transmitting information to said brakes and said APU may be any known form of transmitter, transponder, transceiver or other information communicating means. Preferably said information is transmitted wirelessly for example via infrared, optical, laser, Bluetooth, radio, radar or any other known wireless information transmittal means. An advantage of this is that no wire has to be attached, detached or stored. Alternatively said information is transmitted using electric cables, optical cables, or any other known form of wire. A wire may be detachable at one or both ends, that is, the nosewheel end and the control unit end. An advantage of this is that a reliable connection is always maintained.

Both said receiving means for receiving information, both at said brakes and at said APU may be a direct conversion receiver or any known form of receiver, transponder, transceiver or other known form of information receiving means. Said receiving means send signals to said brakes and said APU respectively, to cause said brakes to be applied/released and said APU to be turned on/off respectively as required by the received signals.

Said parking brakes are the built-in aircraft parking brakes and are preferably independent of any mechanical or electrical nosewheel braking system. However, said parking brakes may be the mechanical or electrical brakes installed in said nosewheel propulsion system. The term ‘applying said parking brakes’ is intended to include the engagement of a parking brake lever where appropriate, and the term ‘releasing the parking brakes’ its disengagement. Said parking brakes may use hydraulic pressure. Said parking brakes are preferably on the main wheel of said aircraft, under the wings, but may also or alternatively be on the nosewheel or any wheel or combination of wheels.

Said parking brakes may also be operable from the aircraft cockpit. A pilot-end control-transferring safety feature may be installed wherein control of said parking brakes cannot be transferred from said cockpit to the remote control unit of this patent unless the pilot deactivates said safety feature. An advantage of this is that ground staff cannot release the parking brakes and commence moving said aircraft until the pilot has given permission. The pilot is better informed than the ground staff about conditions on the aircraft, for example, whether passengers have dismounted or are seated safely. A ground-end control-transferring safety feature may be installed wherein control of said parking brakes cannot be transferred from said remote control unit to said cockpit unless a ground staff member deactivates said safety feature. An advantage of this is that it would prevent a pilot releasing the parking brakes while maintenance is still taking place on his aircraft, of which he is unaware, or while chocks are still in place under the wheels, for example.

Said parking brakes respond to signals at said means for receiving information at said brakes by applying or releasing for a one signal or a zero signal respectively.

Said APU is the built-in aircraft APU or auxiliary power unit, which provides power to the parking brakes and to other non-flight functions of the aircraft, such as air conditioning, lighting, etc. It is usually necessary to turn on said APU in order to use said brakes, although in the case of hydraulic parking brakes, enough energy may be retained in the brakes for one or two applications. It is usually advisably to turn off an APU when no aircraft functions are in use, in order to save power. Said APU may be any form of APU in any location on an aircraft. In the case where an aircraft has no APU, the aircraft turbines may be used in place of the APU for the purposes of this patent. In the case where an aircraft has more than one APU, more than one APU control means may be provided on said control unit, one control means corresponding to each APU. For example, there may be a first switch to turn on and off the APU which controls the parking brakes under normal operation, and a second switch to turn on and off a second APU which is used only in the case of failure of the first. Alternatively, a second (or third, fourth, etc) switch or other control means may turn on and off an APU which powers some other aircraft function which it is desirable to control from outside the aircraft, for example, external aircraft lights.

The apparatus may further comprise means for transferring power supply between APUs, such that in the case of failure of a first APU, power can be supplied from a second or other additional APU. This means may be a switch, lever, button, or other control means.

Preferably, there is one switch for one APU which powers said parking brakes, and one switch controlling said parking brakes, and a suggested typical method of operation is to turn the APU switch to on, use the brake switch to release said parking brakes, use a control arm or the like for moving the aircraft to the desired location, use the brake switch to apply the parking brakes, and use the APU switch to turn off the APU.

Alternatively, the apparatus may comprise one switch (or any other form of control means such as push button, slider, optical sensor, touchpad, heat sensor, etc) which performs the combined functions of the APU switch and the brake switch, that is, the switch in the on position turns on the APU, applies the brakes, and turns off the APU, while the switch in the off position turns on the APU, releases the brakes, and turns off the APU. An advantage of this is that fewer switches need to be pressed. A disadvantage is that the aircraft cannot be moved in between releasing and applying the brakes, because the APU is turned off and there is no separate APU control means. This could be rectified by incorporating the same APU functionality into a control arm or the like for controlling the movement of the aircraft, that is, the APU would be automatically switched on before, and off after, movements of the arm or the like. An advantage of this is that there is no need for a separate APU switch. A disadvantage is that it is impossible to switch on the APU, for example for testing purposes, without performing some other function.

Said APU responds to signals at said means for receiving information at said APU by turning on or off for a one signal or a zero signal respectively.

1. An apparatus for remotely controlling an aircraft having a self-propelled nosewheel, on the ground, comprising:
parking brakes
control means for applying and releasing said parking brakes
transmitting means for transmitting information to the parking brakes of said aircraft
receiving means for receiving information at the parking brakes of said aircraft.

2. An apparatus for remotely controlling an aircraft having a self-propelled nosewheel, on the ground, comprising:
an APU on said aircraft
control means for turning on and off said APU
transmitting means for transmitting information to said APU
receiving means for receiving information at said APU.

3. An apparatus for remotely controlling an aircraft having a self-propelled nosewheel, on the ground, comprising:
parking brakes
an APU on said aircraft
control means for applying and releasing said parking brakes
control means for turning on and off said APU
transmitting means for transmitting information to said parking brakes and said APU
receiving means for receiving information at said parking brakes
receiving means for receiving information at said APU.

4. The apparatus of claim 1, 2 or 3 further comprising:
means for communicating with said self-propelled nosewheel to control the speed of motion of said aircraft.

5. The apparatus of claim 1, 2 or 3 further comprising:
means for communicating with said self-propelled nosewheel to control the direction of travel of said aircraft.

6. The apparatus of any of claims 1-5, wherein said control means are one or more selected from the list comprising switch, lever, push button, slider, touch pad, optical sensor, heat sensor.

7. The apparatus of any of claims 1-5, wherein said control unit is located at a location selected from the list comprising: the ground near an airport gate, mounted on fixed equipment near an airport gate, mounted on portable airport gate equipment, mounted on portable airport equipment, a maintenance hangar, a runway, a taxiway, an apron.

8. The apparatus of any of claims 1-5, wherein said control unit further comprises a security cover.

9. The apparatus of any of claims 1-5, wherein said control unit further comprises a transmittal-restricting safety feature.

10. The apparatus of claim 3, wherein said APU control means and said brake control means are situated in a common control unit.

11. The apparatus of claim 3, wherein said APU control means and said brake control means are situated in separate control units.

12. The apparatus of any of claims 1-5, wherein said transmitting means is one selected from the list comprising: transmitter, transponder, transceiver.

13. The apparatus of any of claims 1-5, wherein said transmitting means transmits information by a means selected from the list comprising:
infrared, optical, Bluetooth, laser, radio, radar, electrical cable, optical cable.

14. The apparatus of any of claims 1-5, wherein said transmitting means transmits information via a cable and said cable is detachable from said control unit.

15. The apparatus of any of claims 1-5, wherein said transmitting means transmits information via a cable and said cable is detachable from said aircraft.

16. The apparatus of any of claims 1-5, wherein said receiving means are one selected from the list comprising receiver, transponder, transceiver.

17. The apparatus of any of claims 1-5, further comprising a pilot-end control-transferring safety feature.

18. The apparatus of any of claims 1-5, further comprising a ground-end control-transferring safety feature.

19. The apparatus of any of claims 2-5, further comprising:
one or more additional APUs on said aircraft;
one or more additional APU control means for turning on and off said second APU
transmitting means for transmitting information to said one or more additional APUs
receiving means for receiving information at said one or more additional APUs.

20. The apparatus of claim 19 further comprising means for transferring power supply between APUs.

21. An apparatus for remotely controlling an aircraft having a self-propelled nosewheel, on the ground, comprising a single control means for consecutively performing the steps of:
turning on the APU of said aircraft;
performing one of applying and releasing the parking brakes of said aircraft; and
turning off the APU of said aircraft;
further comprising:
parking brakes
an APU on said aircraft
transmitting means for transmitting information to said parking brakes and said APU
receiving means for receiving information at said parking brakes
receiving means for receiving information at said APU.

22. The apparatus of claim 21 further comprising a single control means for consecutively performing the steps of:
turning on the APU of said aircraft;
controlling the movement of said aircraft; and
turning off the APU of said aircraft;
further comprising:
a control arm for controlling the movement of said aircraft
transmitting means for transmitting information to said control arm
receiving means for receiving information at said control arm.

23. The apparatus of any preceding claim, further comprising an emergency stop feature.

24. The apparatus of any preceding claim, further comprising a fire suppression feature.
